(19) United States
(12) Patent Application Publication
(10) Pub. No.: US 2026/0228453 A1
(43) Pub. Date: Aug. 6, 2026

(54) INFORMATION PROCESSING METHOD

(71) Applicant: TOYOTA JIDOSHA KABUSHIKI KAISHA, Toyota-shi (JP)

(72) Inventor: Masayuki OKAMOTO, Nagoya-shi (JP)

(73) Assignee: TOYOTA JIDOSHA KABUSHIKI KAISHA, Toyota-shi (JP)

(21) Appl. No.: 19/456,182

(22) Filed: Jan. 22, 2026

(30) Foreign Application Priority Data
Feb. 4, 2025 (JP) 2025-017097

(51) Int. Cl. G06F 40/40; G06F 40/279

(52) U.S. Cl. CPC G06F 40/40; G06F 40/279

(57) ABSTRACT

An information processing method performed by an information processing apparatus includes displaying text information acquired by recognizing an audio signal of a user's speech on a display when conducting a chat to extract know-how from the user using a language model, and correcting, according to a correction in the text information, another portion of the text information that is related to a corrected portion.

### CROSS-REFERENCE TO RELATED APPLICATION

This application claims priority to Japanese Patent Application No. 2025-017097, filed on February 4, 2025, the entire contents of which are incorporated herein by reference.

### TECHNICAL FIELD

The present disclosure relates to an information processing method.

### BACKGROUND

Technology related to learning systems for knowledge, know-how, and the like has been known. Patent Literature (PTL) 1 discloses creating second-level script data based on first-level script data, and outputting a lecture including audio that vocalizes text data of the second-level script data and video of an avatar instructor.

### Citation List

### Patent Literature

PTL 1: JP 7473270 B1

### SUMMARY

However, the conventional configuration has room for improvement regarding the post-correction of errors in speech recognition results in a machine learning-based spoken dialogue interface. For example, when the same error occurs in multiple portions of the recognition result text after a dialogue, collective correction of the error thereafter has not been taken into consideration.

It would be helpful to improve the post-correction of errors in speech recognition results.

According to the present disclosure, an information processing method is an information processing method performed by an information processing apparatus, the information processing method including:

displaying text information acquired by recognizing an audio signal of a user's speech on a display when conducting a chat to extract know-how from the user using a language model; and

correcting, according to a correction in the text information, another portion of the text information, the other portion being related to the corrected portion.

According to an embodiment of the present disclosure, it is possible to improve the post-correction of errors in speech recognition results.

### BRIEF DESCRIPTION OF THE DRAWINGS

In the accompanying drawings:

FIG. 1 is a block diagram illustrating an example of a configuration of an information processing apparatus according to an embodiment; and

FIG. 2 is a flowchart illustrating an example of operations of the information processing apparatus according to the embodiment.

### DETAILED DESCRIPTION

An embodiment of the present disclosure will be described below with reference to the drawings.

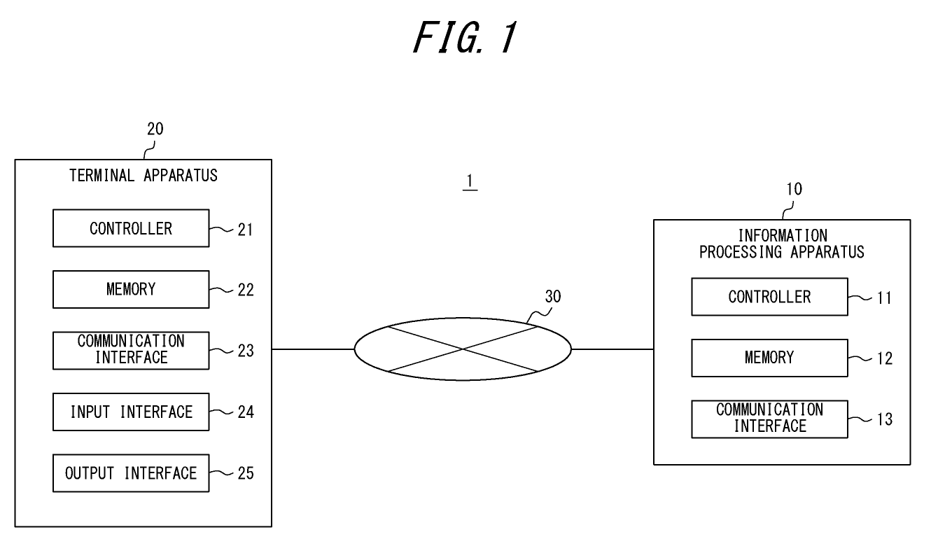

FIG. 1 is a diagram illustrating a configuration of an information processing system 1 according to the embodiment of the present disclosure. The configuration and outline of the information processing system 1 according to the embodiment of the present disclosure will be described with reference to FIG. 1.

The information processing system 1 includes an information processing apparatus 10 and a terminal apparatus 20. The information processing apparatus 10 and the terminal apparatus 20 are communicably connected via a network 30.

The information processing apparatus 10 is, for example, a server apparatus. The information processing apparatus 10 includes a language model. In the present embodiment, the language model includes any dialogue system such as a large language model (LLM) or a chatbot. The information processing apparatus 10 can execute a chat to extract know-how from the user using a language model. For example, the information processing apparatus 10 can output questions to the user via the terminal apparatus 20. Additionally, for example, the information processing apparatus 10 can acquire the user's answers to the questions via the terminal apparatus 20.

The terminal apparatus 20 is any apparatus used by the user. The terminal apparatus 20 is, for example, a general purpose electronic device such as a smartphone, a tablet, a wearable device, or a personal computer (PC), or a dedicated electronic device.

The network 30 is any communication network that allows communication between devices, and may include, for example, the internet and mobile communication networks.

An outline of the present embodiment will be first described, and details thereof will be described later. The information processing apparatus 10 can execute a chat to extract know-how from the user. The information processing apparatus 10 can execute a chat using a language model.

Here, know-how refers to specific or specialized knowledge, skills, techniques, or information. For example, tasks such as screwing or assembly, operation of applications or software, or procedures for conducting business can be subjects of know-how.

The information processing apparatus 10 executes a chat to extract know-how from the user. The user may be a veteran who possesses various knowledge and information, for example. When the information processing apparatus 10 conducts a chat to extract know-how from the user, it recognizes the audio signal of the user's speech and displays the acquired text information on the display. The information processing apparatus 10 corrects other portions of the text information that are related to the corrected portion (words, phrases, etc.) in accordance with corrections made by the user in the text information.

The device operated by the user when executing the chat is the terminal apparatus 20. When executing a chat to extract know-how from the user, the user conducts a voice dialogue with the information processing apparatus 10 via the terminal apparatus 20. The information processing apparatus 10 displays the chat screen via the terminal apparatus 20.

As illustrated in FIG. 1, the information processing apparatus 10 includes a controller 11, a memory 12, and a communication interface 13. The controller 11 includes at least one processor. The processor is a general-purpose processor such as a CPU (Central Processing Unit) or a dedicated processor specialized for specific processing. The controller 11 executes processes related to operations of the information processing apparatus 10 while controlling components of the information processing apparatus 10. The memory 12 includes at least one semiconductor memory, magnetic memory, or optical memory. The memory 12 functions, for example, as a main storage device or auxiliary storage device. The memory 12 stores data to be used in the operations of the information processing apparatus 10 and data obtained by the operations of the information processing apparatus 10. The communication interface 13 includes at least one external communication interface. The interface for communication may be either a wired or wireless communication interface. In the case of wired communication, the communication interface is, for example, a Local Area Network (LAN). In the case of wireless communication, the communication interface is, for example, an interface compatible with mobile communication standards such as 5G, or an interface compatible with short-range wireless communication. The communication interface 13 receives data to be used for the operations of the information processing apparatus 10, and transmits data obtained by the operations of the information processing apparatus 10.

The functions of the information processing apparatus 10 are realized by executing a program according to the present embodiment by a processor corresponding to the controller 11. That is, the functions of the information processing apparatus 10 are realized by software. The program causes a computer to execute operations of the information processing apparatus 10, thereby causing the computer to function as the information processing apparatus 10. That is, the computer executes the operations of the information processing apparatus 10 in accordance with the program to thereby function as the information processing apparatus 10. In the present embodiment, the program can be recorded on a computer readable recording medium. The computer readable recording medium includes a non-transitory computer readable medium and is, for example, a magnetic recording apparatus or a semiconductor memory. The program is distributed, for example, by selling, transferring, or lending a portable recording medium such as a DVD on which the program is recorded. The program may also be distributed by storing the program in a storage of an external server and transmitting the program from the external server to another computer. The program may be provided as a program product. Some or all of the functions of the information processing apparatus 10 may be realized by a dedicated circuit corresponding to the controller 11. That is, some or all of the functions of the information processing apparatus 10 may be realized by hardware.

As illustrated in FIG. 1, the terminal apparatus 20 includes a controller 21, a memory 22, a communication interface 23, an input interface 14, and an output interface 25. The functions and configurations of the controller 21, memory 22, and communication interface 23 of the terminal apparatus 20 are similar to those of the controller 11, memory 12, and communication interface 13 of the information processing apparatus 10, so detailed explanation is omitted. The input interface 24 includes at least one interface for input. The interface for input may be, for example, a physical key, a touch screen, an audio sensor (microphone) that accepts audio input, or a camera that accepts gesture input. The input interface 24 accepts an operation for inputting data to be used for the operations of the terminal apparatus 20. The output interface 25 includes at least one interface for output. The interface for output is, for example, a display unit (display) for outputting information in the form of images, or a speaker for outputting information in the form of audio. The output interface 25 outputs data obtained by the operations of the terminal apparatus 20. Some or all of the functions of the terminal apparatus 20 may be realized by software, similar to the information processing apparatus 10, or may be realized by hardware.

### Operations of Information Processing System 1

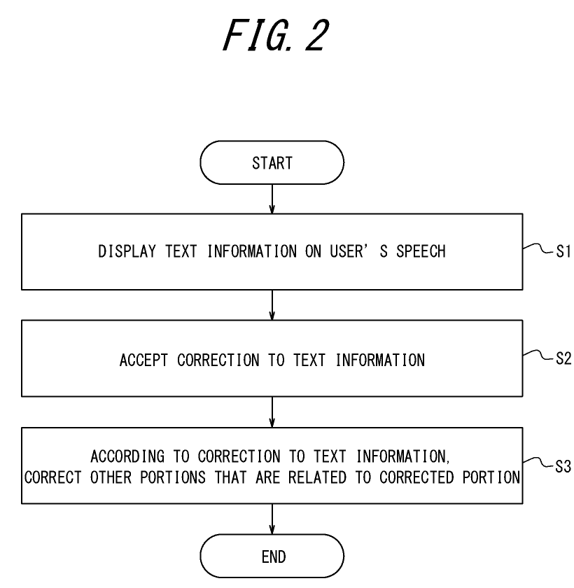

Operations of the information processing system 1 are described with reference to the flowchart in FIG. 2. The operations of the information processing system 1 described with reference to FIG. 2 may correspond to one of the information processing methods executed by the information processing apparatus 10. The operation of each step in FIG. 2 may be executed based on control by the controller 11 of the information processing apparatus 10.

S1: When the controller 11 conducts a chat to extract know-how from the user using a language model, it displays the text information obtained by recognizing the audio signal of the user's speech on the display (output interface 25).

The user is a veteran who possesses various knowledge and information about the know-how they are trying to extract. The memory 12 stores the language model. The language model may be, for example, a Large Language Model (LLM). The controller 11 can execute a chat to extract know-how from the user using the language model stored in the memory 12. The controller 11 may conduct the chat using voice when executing the chat. In addition to the text information obtained by recognizing the audio signal of the user's speech, the controller 11 may display the text information of the speech output from the system in response to the user's speech on the display (output interface 25).

The controller 11 may indicate portions in the text information obtained by voice recognition that may have misrecognition with wavy lines or the like. The controller 11 may determine the possibility of misrecognition based on context (for example, technical terms) and similarity of the audio signal.

S2: The controller 11 accepts corrections to the text information displayed on the display (output interface 25) from the user.

Specifically, the controller 11 may accept corrections to the text information through manual operations (for example, touch operations, operations using a pointing device/keyboard, etc.). Alternatively, the controller 11 may accept corrections to the text information through spoken instructions (for example, rephrasing in clear speech). The controller 11 may accept settings for each correction target (for example, the word before correction) and correction content (for example, the word after correction) either manually or through speech.

S3: The controller 11 corrects other portions related to the corrected portion in response to the correction of the text information in S2.

Specifically, the controller 11 may determine the presence or absence of relevance to the corrected portion based on at least one of the identity or similarity of a word in the text information after recognition and the similarity of the audio signal used for recognizing that word. The similarity of the audio signal may be identified by features such as phonemes and MFCC (Mel-Frequency Cepstral Coefficient).

Corrections of other portions may be performed collectively within the text information or may be performed one by one while receiving confirmation from the user for each unit of voice recognition (for example, word, phrase, etc.). That is, when a correction is made to the text information, the controller 11 may automatically correct all other portions included in the text information that are related to the corrected portion. Alternatively, when a correction is made to the text information, the controller 11 may confirm with the user whether to correct each of the other portions included in the text information that are related to the corrected portion and correct them according to the user's confirmation.

The controller 11 accepts a selection of the range of text information to be corrected from the user and may perform corrections on the selected range. For example, the controller 11 may accept a selection of the correction range based on a temporal range (from when to when) and which lines of the text information (from which line to which line). The controller 11 may accept similar corrections not only for the user's speech but also for the system's speech output that is generated in response to the user's speech. That is, when a correction is made to the text information, the controller 11 may correct a portion of the text information output in response to the user's speech, which is related to the corrected portion.

The correction content may include errors in speech (for example, "axial force" and "actual ability") as well as mistakes involving homophones (for example, "breakdown" and "breakup"). The controller 11 may tune the parameters of the model used for speech recognition of the user's speech in response to the correction. The controller 11 may perform synonym consolidation (for example, resolving variations in notation and duplicates) in response to the correction.

As described above, in the information processing apparatus 10 according to the present embodiment, the controller 11 recognizes the audio signal of the user's speech and displays the text information obtained on the display (output interface 25) when conducting a chat to extract know-how from the user using a language model. In response to a correction in the text information, the controller 11 corrects another portion of the text information that is related to the corrected portion. Thus, the information processing apparatus 10 can efficiently and simply correct errors in the speech recognition results by collectively fixing other similar errors in the text in response to a correction made to one part of the text information.

The present disclosure is not limited to the embodiment described above. For example, a plurality of blocks described in the block diagram may be integrated, or a block may be divided. Instead of executing a plurality of steps described in the flowchart in chronological order in accordance with the description, the plurality of steps may be executed in parallel or in a different order according to the processing capability of the apparatus that executes each step, or as required. Other modifications can be made without departing from the spirit of the present disclosure.

For example, some of the processing operations executed in the information processing apparatus 10 in the above embodiment may be executed in the terminal apparatus 20. Also, some of the processing operations executed in the terminal apparatus 20 in the above embodiment may be executed in the information processing apparatus 10.

1. An information processing method performed by an information processing apparatus, the information processing method comprising:
displaying text information acquired by recognizing an audio signal of a user's speech on a display when conducting a chat to extract know-how from the user using a language model; and
correcting, according to a correction in the text information, another portion of the text information, the other portion being related to a corrected portion.

2. The information processing method according to claim 1, comprising determining presence or absence of relevance to the corrected portion, based on identity or similarity of a word in the text information after recognition and/or similarity of the audio signal used for recognizing that word.

3. The information processing method according to claim 1, comprising, when a correction is made to the text information, correcting all other portions included in the text information, all the other portions being related to the corrected portion.

4. The information processing method according to claim 1, comprising, when a correction is made to the text information, correcting each of other portions included in the text information according to the user's confirmation, each of the other portions being related to the corrected portion.

5. The information processing method according to claim 1, comprising, when a correction is made to the text information, correcting a portion of text information output in response to the user's speech, the portion being related to the corrected portion.
